(19) United States
(12) Patent Application Publication
(10) Pub. No.: US 2012/0293986 A1
(43) Pub. Date: Nov. 22, 2012

(54) HEAD LAMP COMPRISING ARCH-SHAPED HEAD BAND LOCATED ON SAGITTAL SUTURE PLANE

(76) Inventor: Gichun Kim, Seoul (KR)

(21) Appl. No.: 13/322,548

(22) PCT Filed: Jan. 10, 2011
(86) PCT No.: PCT/KR11/00141

§ 371 Date: Nov. 25, 2011

(30) Foreign Application Priority Data
Feb. 6, 2010 (KR) 10-2010-0011250

(51) Int. Cl. F21V 21/084

(52) U.S. Cl. 362/105

(57) ABSTRACT

The present invention relates to a head lamp used for mounting a light source on the head, wherein the head lamp comprises a bow-shaped bent head on the sagittal suture plane of a wearer. The head lamp is lightweight, ruins the hairstyle of the wearer less, does not impede the circulation of blood and causes less headaches.

### TECHNICAL FIELD

The present invention relates to a head lamp mounted on the head of a wearer, and more particularly, to a head lamp which is mounted on the head of a wearer such as a doctor or an operator during a surgery or during work and emits light to the surgical operation area or working area. The head lamp may be attached with a device such as a magnifying glass or a camera.

### BACKGROUND ART

A conventional ring-shaped head band extends from the forehead to the back of the head via the temporal region and is located in the horizontal plane to mount a head lamp, a magnifying glass or a camera on the head of a wearer. To improve stability, a crown-shaped head band which employs the ring-shaped head band and an auxiliary band extending from opposite temporal regions to the crow part of the head has been used.

### DISCLOSURE

### Technical Problem

However, the ring-shaped head band or the crown-shaped head band is heavy in weight, and fastens the entire head. This ruins hairstyle, presses the temporal arteries when the head band is mounted on the head for a long time and impedes the circulation of blood and causes headache.

### Technical Solution

In order to achieve the object of the present invention, a head lamp according to the present invention includes an arch-shaped head band, and removes the ring-shaped part fastening the entire head of a wearer and transfers a load through a sagittal suture plane of the wearer.

### Advantageous Effect

As described above, if a head lamp, a magnifying glass or a camera is mounted on the head of a wearer by using the aforementioned head band, the weight of the head band may be reduced, the hairstyle is not ruined much, the circulation of blood is not impeded and headache is reduced.

### BRIEF DESCRIPTION OF DRAWINGS

FIG. 1 is a perspective view of a head lamp which employs a conventional crown-shaped head band, to which two light sources are attached.

FIG. 2 is a perspective view of a head lamp which employs an arch-shaped head band according to the present invention, to which two light sources are attached.

FIG. 3 is an enlarged perspective view of a head band length adjuster according to the present invention.

### BEST MODE

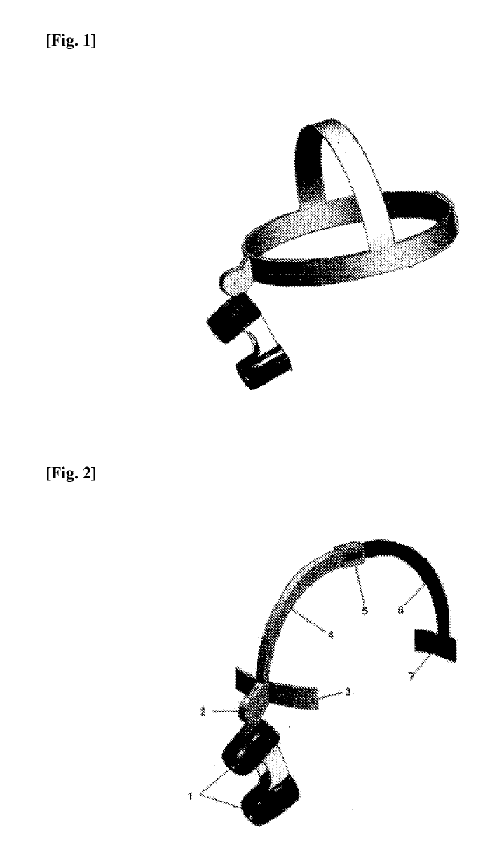

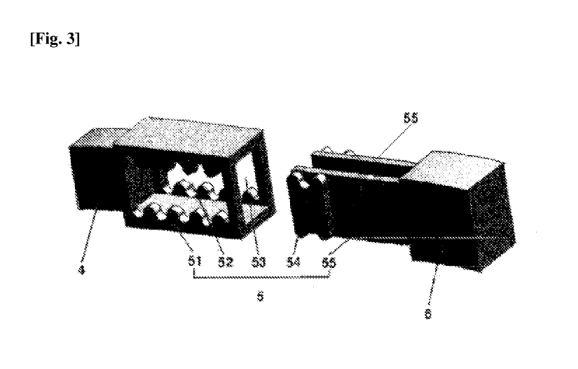

Hereinafter, a head lamp according to an exemplary embodiment of the present invention will be described with reference to accompanying drawings. FIG. 1 is a perspective view of a head lamp which employs a conventional crown-shaped head band, to which two light sources are attached. Detailed description will be omitted. FIG. 2 illustrates a head lamp according to the exemplary embodiment of the present invention. In the present exemplary embodiment, the head lamp includes a light source 1, a connector 2, a front auxiliary band 3, main bands 4, 5 and 6, and a rear auxiliary band 7. The main bands 4, 5 and 6 include a front main band 4, a length adjuster 5 and a rear main band 6. More specifically, the light source 1 is an example of the present exemplary embodiment, and may vary including a magnifying glass or a camera as long as it is mounted on the head.

The two light sources 1 emit light to the front (lower left direction in the drawing) to collect light in a visual range. The light sources 1 are coupled to the main bands 4, 5 and 6 through the connector 2.

The connector 2 is provided in a front side of the main bands 4, 5 and 6, i.e., in a front end of the front main band 5 and connects the light sources 1 to the main bands 4, 5 and 6. The connector 2 connects the light sources 1 and the main bands 4, 5 and 6 by hinge or ball and socket to change the light direction of the light sources 1.

The front auxiliary band 3 includes a pair of cantilevers which extend from the front side of the main bands 4, 5 and 6, i.e., from a front end of the front main band 4 to the left and right sides in a horizontal direction, and contacts the forehead of a wearer when the wearer wears the head lamp. The front auxiliary band 3 distributes the load concentrated on the forehead of the wearer. Opposite ends of the front auxiliary band 3 may be bent backwardly from a horizontal plane. Then, when a wearer wears the head lamp and moves his/her head, the head lamp may be prevented from moving to the left and right sides, increasing stability.

The front main band 4 is a bow-shaped beam which protrudes from a central part of the head lamp to front and lower sides. The connector 2 is provided in a front end of the front main band 4, and the front auxiliary band 3 extends from both sides of the front main band 4. A rear end of the front main band 4 is connected to the length adjuster 5. The front main band 4 contacts the head of a wearer and transfers the weight of the head lamp to the head of the wearer together with the rear main band 6 (to be described later). Not to ruin the hairstyle, only the front auxiliary band 3 and the rear auxiliary band 7 may contact the forehead and the back of the head instead of the front main band 4 and the rear main band 6. In this case, the frictional force between the front auxiliary band 3 and the forehead and the frictional force between the rear auxiliary band 7 and the back of the head corresponds to the entire load of the head band and the light sources 1. As the frictional force is proportional to reaction, the front main band 4 and the rear main band 6 may include an elastic material to generate elastic force. The reaction generated between the front auxiliary band 3 and the forehead and between the rear auxiliary band 7 and the back of the head creates a moment in the main bands 4, 5 and 6. This moment increases toward a central part of the main bands 4, 5 and 6 (i.e., in the vicinity of the length adjuster 5 according to the present exemplary embodiment). To efficiently respond to the foregoing moment, the head lamp may be designed to increase the moment of inertia toward the central part of the main bands 4, 5 and 6 with respect to a horizontal axis perpendicular to a lengthwise direction of the section perpendicular to the lengthwise direction of the main bands 4, 5 and 6.

The length adjuster 5 is provided between the front main band 4 and the rear main band 6. The length adjuster 5 will be described later in more detail for purposes of convenience after the rear main band 6 and the rear auxiliary band 7 are explained.

The rear main band 6 is a bow-shaped beam extending from the rear side to a lower side of the length adjuster 5. The rear auxiliary band 7 protrudes to both left and right sides from a rear end of the rear main band 6. A rear connector may be installed in a rear end of the rear main band 6 as necessary. The foregoing rear connector may be connected with a battery supplying power to the light sources 1 or an electrical connector supplying power to the light sources 1 from the outside, which is not shown in drawings.

The rear auxiliary band 7 includes a pair of cantilevers which extend from a rear end of the head lamp, i.e., a rear end of the rear main band 6 to the left and right sides, and contacts the back of the head of a wearer where the wearer wears the head band. Opposite ends of the rear auxiliary band 7 may be designed to be bent forwardly. Then, the head lamp may be prevented from moving to the left and right sides when a wearer wears the head lamp, increasing stability. Further, like the front auxiliary band 3, the rear auxiliary band 7 distributes the load concentrated on the back of the head of a wearer.

Hereinafter, the length adjuster 5 will be described with reference to FIG. 3. The length adjuster 5 is provided between the front and rear main bands 4 and 6, and adjusts the front and rear length of the main bands 4, 5 and 6. The length adjuster 5 includes a mold 51 and a plug 55. The mold 51 is shaped like an empty box extending from a rear side of the front main band 4, and includes two side holes 52 formed in both sides and one rear hole 53 formed in a rear side thereof. The side holes 52 have upper and lower sides shaped like a tooth, and are shaped like a rectangle as a whole. The rear hole 53 is shaped like a rectangle. The plug 55 is inserted into the rear hole 53. The plug 55 includes two arms which have a rectangular section and protrude from a front end of the rear main band 6. A fixing button 54 protrudes from opposite lateral sides of the front side of the plug 55. The fixing button 54 has two upper and lower projections shaped like a tooth. If the fixing button 54 is pressed from the left and right sides, a gap between the two arms of the plug 55 is reduced and the plug 55 may be inserted into the rear hole 53.

An operation process of the length adjuster 5 will be described. The plug 55 is inserted into the rear hole 53 by pressing the two fixing buttons 54. If the two fixing buttons 54 are released from the pressure, the two arm-shaped plugs 55 widen by the restoring force. The projection shaped like a tooth and formed in the fixing buttons 54 and the projection shaped like a tooth and formed in the rear hole 53 are engaged with each other and fixed in a designated location. The foregoing process may be repeated to adjust the length of the main bands 4, 5 and 6.

Another wearer with a different head size may adjust the length of the main bands 4, 5 and 6 through the length adjuster 5 and easily wear the head lamp, magnifying glass or a camera. The length adjuster 5 according to the present exemplary embodiment is an example of adjusting the front and rear length of the head lamp, and there can be other various methods for adjusting the length of the head lamp. For example, instead of dividing the main bands of the head lamp into the front and rear main bands 4 and 6, a single bow-shaped main band extending from the forehead to the back of the head may be provided and a rear auxiliary band contacting the back of the head may be provided to move forwardly according to the size of the head. Any method is applicable as long as it adjusts the length from the rear side of the front auxiliary band to the front side of the rear auxiliary band according to a head size of a wearer.

The head lamp is lighter in weight, ruins the hairstyle of the wearer less, does not impede the circulation of blood and causes less headaches than the conventional head lamp. Thus, the head lamp according to the present invention provides better convenience than the conventional head lamp.

### INDUSTRIAL APPLICABILITY

The head lamp according to the present invention may be used not only when a doctor treats a patient but also in work environments where lighting is needed.

1. A head lamp which is worn by a wearer to mount at least one light source on the head of the wearer, the head lamp comprising:
a bow-shaped main band which is concave on a sagittal suture plane of a wearer;
a connector which is provided to couple the light source to at least one end of the main band;
a front auxiliary band which is shaped like a pair of cantilevers protruding from a front end of the main band to the left and right sides;
a rear auxiliary band which is shaped like a pair of cantilevers protruding from a rear end of the main band to the left and right sides;
the front and rear auxiliary bands not connected to each other without the main band, and
a length adjuster which adjusts a length from a rear surface of the front auxiliary band to a front surface of the rear auxiliary band.

2. The head lamp according to claim 1, wherein the length adjuster is provided in a central part of the main band.

3. The head lamp according to claim 2, wherein a section which is a perpendicular to a lengthwise direction of the main band has an increasing moment of inertia with respect to a horizontal axis perpendicular to the lengthwise direction of the main band from both ends of the main band to a central part thereof.

4. The head lamp according to claim 1, wherein the front auxiliary band is concave backwardly in a horizontal direction and the rear auxiliary band is concave forwardly in a horizontal direction.

5. The head lamp according to claim 1, wherein the connector connects the light sources and the main band by hinge or a ball and socket joint to ensure a relative movement between the light sources and the main band.
